(19) United States
(12) Patent Application Publication
(10) Pub. No.: US 2009/0029335 A1
(43) Pub. Date: Jan. 29, 2009

(54) Educational system and improved teaching method

(76) Inventor: Anna Marie Gyaraki, Palm Beach Gardens, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/782,396

(22) Filed: Jul. 24, 2007

(51) Int. Cl. G09B 3/00

(52) U.S. Cl. 434/350; 434/309

(57) ABSTRACT

An educational system and improved method for teaching students using lessons taught by both a live teacher and by recorded multimedia presentations. The teacher teaches a lesson to the students, and then, divides the students into subgroups assigned to different workstations. Each workstation can include a different but related recorded lesson stored on a recording medium and at least one recording playback device for playing audio and video recordings. After the live lesson, the students begin the recorded lessons at their assigned workstations. The students are required to watch and listen to a recorded lesson and are rotated among workstations to view and listen to each recorded lesson. To determine each student's mastery of the lesson, the students are tested on the subject matter presented by the recorded lesson. Students who fail to meet a predetermined level of performance on the test are required to repeat the lesson.

### FIELD OF THE INVENTION

The invention relates generally to the field of education. More particularly, the invention relates to an educational workstation system and improved method for teaching students using recorded presentations in a classroom setting.

### BACKGROUND

The classroom is the traditional setting where formal education takes place. At the elementary school level, a large group of students are taught most of the day by a single teacher or sometimes two or more teachers. This method is less than ideal because no two students are alike. Rather students in a typical classroom display a wide spectrum of abilities, interests, and learning styles. Some will learn more quickly and thoroughly from a particular teaching style or method, while other students will not learn effectively with that style or method. Thus, when a teacher is teaching an entire class, not all of the students are learning effectively. One solution to this dilemma is to have smaller class sizes where a teacher can better cater to the individual learning needs of each student. Unfortunately, for the vast majority of students, budget constraints prevent having a low student to teacher ratio.

### SUMMARY

The invention relates to the development of systems, devices, and methods that allow a single teacher to simultaneously teach all students in a large class in a small group setting so that the learning needs of individual students can be better met. To achieve this, the systems, devices, and methods of the invention employ a series of recorded presentations (e.g., audiovisual recordings of a live teacher's lecture) that feature an actual teacher. The class is broken down into 2, 3, 4, 5, 6 or more subgroups of 1, 2, 3, 4, 5, 6, 7 or more students, and each subgroup can be assigned to a different workstation. The different workstations are preferably located in a single classroom so that a single teacher can be easily accessed by the students, if needed. A different lesson or the same lesson taught in a different style or method (e.g., primarily visual teaching versus primarily verbal teaching) can be presented in each workstation. The teacher can present live instruction to one of the subgroups, while the other subgroups are taught by a video recording of a teacher.

In an exemplary method of the invention, a live teacher first presents a lecture in a particular subject (e.g., reading) to a class. The class is then divided into several subgroups and sent to different workstations where the lesson and other areas of instruction are supplemented or reinforced. In those workstations without a live teacher, the students can be encouraged to work through a lesson in various ways. For example, each student in a particular subgroup can be given a different task to complete such as starting a video player, distributing workbooks, or returning a video recording. As another example, the students in each subgroup can be given an activity sheet or even a quiz that would confirm that the student watched the lesson and/or provide an objective evaluation of how well a student learned the lesson. The division of the class into different subgroups may be done on the basis of subject matter needing mastery or on a student's particular learning style. Where desired, particular recorded lessons can be repeatedly presented to students.

A significant advantage of the invention is that it allows a single teacher to effectively address the particular learning needs of the individual students making up a large class. Importantly, educational instruction of students using this method is not so independent as to create or promote disparities within the classroom as to the education received by the students, but rather, the method benefits students by subjecting them to repetitive reinforcement of lessons that are essential to the teacher's curriculum.

Accordingly, the invention features a method for teaching a group of students in a classroom including the steps of presenting a live lecture in an academic subject to the group of students, and dividing the group of students into a plurality of subgroups. The plurality of subgroups may include at least a first subgroup of students and a second subgroup of students. The method also includes the steps of placing the first subgroup of students into a first workstation and placing the second subgroup of students into a second workstation. The first workstation can be separated from the second workstation. The method further includes the step of activating a first recorded lesson in the first workstation having therein the first subgroup of students within ten minutes of the conclusion of the live lecture. The first recorded lesson may relate to the academic subject and may include an audiovisual recording of a person presenting the first recorded lesson.

Another method of the invention may include the step of activating a second recorded lesson in the second workstation having therein the second subgroup of students within ten minutes of the conclusion of the live lecture. The second recorded lesson may also relate to the academic subject, and may include an audiovisual recording of a person presenting the second recorded lesson. The second recorded lesson can differ from the first recorded lesson.

Another method of the invention may include the step of presenting a live lesson to the second subgroup of students in the second workstation within ten minutes of the conclusion of the live lecture.

Another method of the invention may include the step of assigning lessons to the second subgroup of students that are not recorded lessons. These lessons can be assigned to the second subgroup of students within ten minutes of the conclusion of the live lecture.

Another method of the invention may include the step of assigning lessons to the second subgroup of students that are in a different academic subject than the academic subject of the live lecture. These lessons can be assigned to the second subgroup of students within ten minutes of the conclusion of the live lecture.

Another method of the invention may include the step of assigning one of the students of the first subgroup of students with one or more tasks selected from among the following tasks: activating the first recorded lesson, stopping the first recorded lesson, rewinding the first recorded lesson, returning the first recorded lesson to an educator, distributing at least one activity sheet to the students in the first subgroup, collecting the activity sheet from the students in the first subgroup upon completion of the activity sheet by the students, evaluating the activity sheet completed by the students in the first subgroup, distributing at least one quiz to the students in the first subgroup, collecting the quiz from the students in the first subgroup upon completion of the quiz by the students, evaluating the quiz completed by the students in the first subgroup, returning the completed activity sheet to the educator, returning the completed quiz to the educator, distributing at least one book, sample of literature, printed chart or diagram, or manipulative related to the academic subject of the first recorded lesson to the students in the first subgroup, collecting the book, sample of literature, printed chart or diagram, or manipulative from the students in the first subgroup upon completion of the first recorded lesson, returning the book, sample of literature, printed chart or diagram, or manipulative to the educator, and leading a discussion about the first recorded lesson with students in the first subgroup.

Another method of the invention may include the step of providing an activity sheet to each student in the first subgroup of students.

Another method of the invention may include the step of administering a quiz to each student in the first subgroup of students. The quiz may include at least one question in the academic subject.

Another method of the invention may include the step of assigning one of the students of the first subgroup of students to deliver the first recorded lesson upon completion by the first subgroup of students to the second subgroup of students.

Another method of the invention may include the step of reviewing at least one activity sheet completed by one or more students in one or more of the subgroups to determine each student's comprehension and mastery of the academic subject taught by the recorded lesson.

Another method of the invention may include the step of reviewing and grading at least one activity sheet completed by one or more students in one or more of the subgroups to determine each student's comprehension and mastery of the academic subject taught by the recorded lesson.

Another method of the invention may include the step of reviewing and grading at least one test or quiz completed by one or more students in one or more of the subgroups to determine each student's comprehension and mastery of the academic subject taught by the recorded lesson.

Another method of the invention may include the step of requiring students who fail to meet a predetermined level of performance on the test or quiz to repeat one or more of the recorded lessons. Each student's level of performance is indicative of the student's comprehension and mastery of the academic subject taught by the recorded lessons.

Another method of the invention may include the step of requiring that the students in the subgroup completing the recorded lesson discuss the recorded lesson upon the completion of each recorded lesson.

Another method of the invention may include the step of rotating the subgroups of students to different workstations upon completion of one or more recorded lessons to complete additional and different recorded lessons.

Another method of the invention may include the step of providing recorded lessons that relate to the same academic subject but wherein each recorded lesson differs from the other recorded lessons in level of difficulty.

Another method of the invention may include the step of rotating the first recorded lesson to the second subgroup for review and completion of the first recorded lesson by the students of the second subgroup upon completion of the first recorded lesson by the first subgroup.

Another method of the invention may include the step of rotating the second recorded lesson to the first subgroup for review and completion of the second recorded lesson by the students of the first subgroup upon completion of the second recorded lesson by the second subgroup.

Another method of the invention may include the step of providing incentives to students who demonstrate understanding of the academic subject taught by one or more of the recorded lessons.

Another method of the invention may include the step of providing incentives to subgroups of students who demonstrate understanding of the academic subject taught by one or more of the recorded lessons.

Another method of the invention may include the step of assessing each student to determine a manner of teaching in which the student learns most effectively. The manner of teaching used to teach students after completion of the assessment may be selected from among visual lessons, auditory lessons, verbal lessons, kinesthetic lessons, any other suitable manner of teaching students, and combinations thereof.

Another method of the invention may include the step of dividing the students into subgroups based upon the manner in which each student has been assessed to learn most effectively.

Another method of the invention may include the step of using different styles of teaching for each subgroup of students by rotating at least the first recorded lesson, which includes a first style of teaching, and at least the second recorded lesson, which includes a second style of teaching, between the subgroups. The first style of teaching can differ from the second style of teaching.

Another method of the invention may include the step of resuming the live lecture for the entire group of students after an educator assesses the mastery of the subject matter of the recorded lesson by the students as demonstrated by each student's performance on one or more completed evaluation activities. The evaluation activities can include activity sheets, quizzes, tests, teacher observation, teacher dialogue with students, and combinations thereof.

Another method of the invention may include the step of providing remedial live lessons by an educator to students in at least one of the subgroups in the academic subject taught by one or more of the recorded lessons.

Another method of the invention may include the step of replaying one or more of the recorded lessons and providing additional instruction by an educator to the students of at least one of the subgroups as the recorded lesson is played.

Another method of the invention may include the step of replaying one or more of the recorded lessons for at least one subgroup and providing additional instruction by an educator to the students of the subgroup after the recorded lesson is replayed.

Another method of the invention may include the step of providing immediate feedback to the students by including instructions to the students in the recorded lessons for awarding points based upon correct responses by the students to activity sheet, quiz, and test questions.

The invention also features a kit that may include a plurality of recordings of a person presenting a lesson. The plurality of recordings can include at least a first recording of a first lesson and a second recording of a second lesson, and the second lesson may differ from the first lesson. The kit may further include a textbook, samples of literature for review by the students, printed charts and diagrams for review by the students, educational games, manipulatives, activity sheets, quizzes, tests, and a teacher's manual. The textbook can be reviewed and followed by students during a live lecture, during a recorded lesson, or during both the live lecture and the recorded lesson. The teacher's manual, which is to be used by the teacher, can include a version of the textbook used by the students that contains explanations and examples of teaching methods, answers to activity sheets, and answers to quizzes.

The kit of the invention may also feature a first style of teaching used in the first lesson and second style of teaching used in the second lesson where the second style of teaching is different from the first style of teaching.

The kit of the invention may also feature activity sheets that can include questions and exercises for assessing each student's mastery of the lesson and ability to continue with subsequent lessons. The kit may further include quizzes that contain questions and other evaluative exercises for evaluating each student's mastery of the lesson and for providing a grade for each student in an academic subject that is being taught.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1A is a schematic diagram of students being taught a live lesson by a teacher in a classroom.

FIG. 1B is a schematic diagram of the students divided into subgroups and receiving instruction by recorded lessons played at several workstations.

FIG. 2 is a flowchart detailing the steps of a method of the invention.

### DETAILED DESCRIPTION

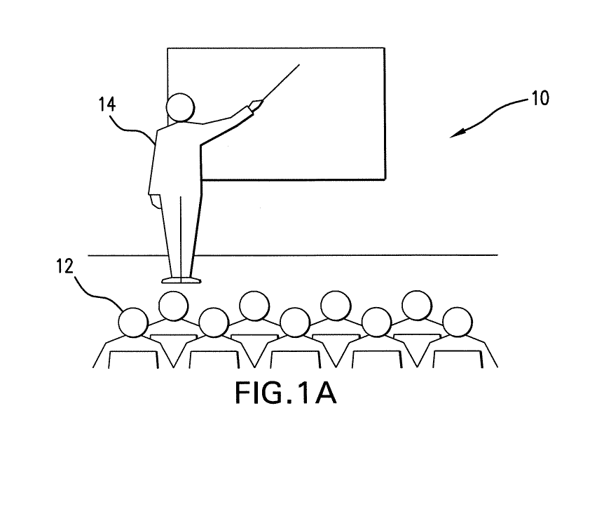

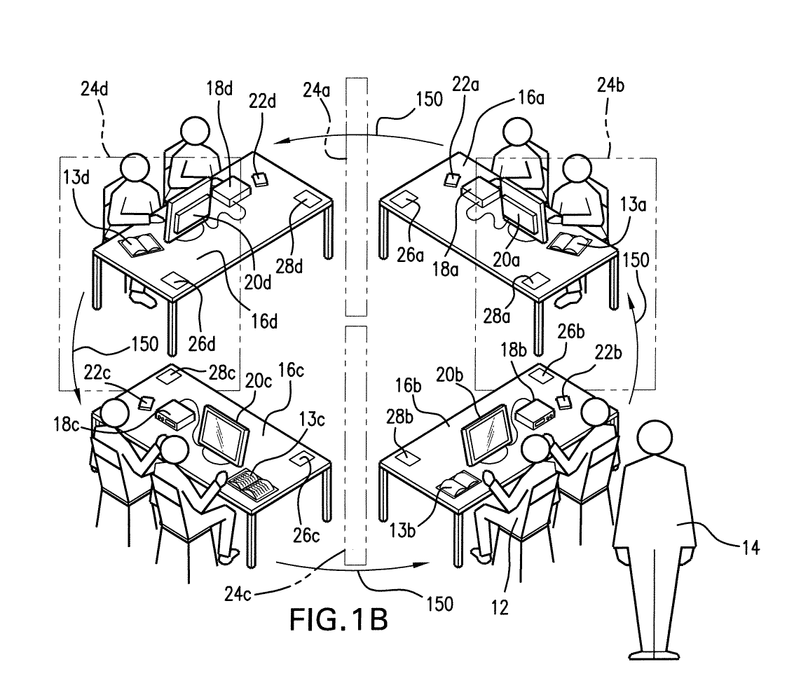

Referring now to FIGS. 1A and 1B, an exemplary embodiment of the invention features a system for teaching students 12 in classroom 10 wherein the system includes a plurality of books 13a, 13b, 13c, and 13d and a plurality of recorded lessons 22a, 22b, 22c, and 22d. The books concern a particular academic subject such as reading, writing, math, social studies, or science. The system may further include activity sheets 26a, 26b, 26c, and 26d and tests or quizzes 28a, 28b, 28c, and 28d. In one embodiment, the system, which may be produced as a kit, may also include other teaching implements such as samples of literature for review by the students, printed charts and diagrams for review by the students, educational games, and teaching manipulatives that can be moved or arranged by hand. The books 13a, 13b, 13c, and 13d can be read or followed by the students 12 during the live lesson. The books 13a-13d may also be read or followed by the students 12 during the recorded lesson. Each book may be written and designed for use with a different recorded lesson, or all of the books may be identical. In an exemplary embodiment, identical books include different sections each of which corresponds to a different recorded lesson.

In FIG. 1A, the teacher 14 is presenting a live lesson to students 12 in a classroom 10. Once the live lesson is completed, the students 12 are divided into two or more (e.g., 2, 3, 4, 5, 6, 7 or more) subgroups each of which is assigned to one of a plurality of workstations 16a, 16b, 16c, and 16d as shown in the embodiment of FIG. 1B. Each of the workstations 16a, 16b, 16c, and 16d can include a power supply and space for locating at least one recording playback device. The workstations 16a, 16b, 16c, and 16d may also include one or more wall elements 24a, 24b, 24c, and 24d and one or more privacy or “modesty” panels, either of which may optionally be attached to the workstations. While not essential to the performance of the method, it is desirable that the workstations 16a, 16b, 16c, and 16d also each include a space sufficient to permit the students to lay paper, writing utensils, and the book. In one embodiment, one or more of the workstations can be a floor space where one or more subgroups of students go to read or engage in other learning activities.

The recording playback devices 18a, 18b, 18c, and 18d are shown in the embodiment of FIG. 1B as DVD players connected to televisions 20a, 20b, 20c, and 20d, however, other media playing devices such as a VCR or DVR or any other suitable device might also be used. Each workstation may also be equipped with a cassette player, portable media player, or record player for playback and recording of audio recordings. In an alternate embodiment of the invention, the recording playback device is a computer connected to a display monitor. The computers at each workstation may be connected to a central server or to a computer communications network such as the Internet, and can include educational software applications or access to internet-based websites providing educational lessons in the form of audio and/or video instructions by a recorded professional teacher.

The recorded lessons 22a, 22b, 22c, and 22d may be recorded and stored on any suitable storage medium such as digital video discs (DVDs), compact discs (CDs), cassettes, or records 22a, 22b, 22c, and 22d. The recorded lessons stored on the storage media 22a, 22b, 22c, and 22d can be played by the recording playback devices 18a, 18b, 18c, and 18d and, where the recorded lessons include video, might be viewed on devices 20a, 20b, 20c, and 20d. Both the recorded lessons and the recordings are referenced herein and identified in the drawings as 22a, 22b, 22c, and 22d.

In an alternate embodiment of the invention, where a computer or portable media player is used as the recording playback device, the recorded lessons may be provided in the form of digital media stored on a computer hard drive or server or as streaming media accessed via the Internet or through an intranet. Headphones may be provided to each student in a subgroup to listen to the recorded lesson, and are particularly desirable in reading and foreign language lessons.

In FIG. 1B, several workstations 16a, 16b, 16c, and 16d are arranged in a classroom and each workstation includes a recorded lesson 22a, 22b, 22c, and 22d as well as devices 18a-18d and 20a-20d for playing and viewing recorded lessons. Books 13a-13d, activity sheets 26a-26d, and tests or quizzes 28a-28d are also present in the workstations in the embodiment shown in FIG. 1B. The device for viewing the recorded lesson may be a television or a computer display monitor. The recorded lessons 22a, 22b, 22c, and 22d are taught by the recorded professional teacher and contain subject matter that may be the same as the subject matter of the live lesson. In one embodiment, the recorded lessons contain related subject matter to teach multiple lessons of one skill in the academic subject. Each recorded lesson may vary in its level of difficulty. The books 13a-13d can be read or followed by the students 12 while watching and listening to the recorded lessons.

The activity sheets 26a-26d may include written practice questions or tutorials that can be evaluated by an educator, such as the teacher or a teacher's aide or assistant, to determine the student's level of mastery of a targeted skill such as understanding the main idea or author's purpose. The activity sheets can be completed by the students either during or after completion of the recorded lesson. Activity sheets can also provide students with an opportunity to apply the knowledge learned from the live lecture given by the live teacher as well as from the recorded lesson. Like tests, activity sheets which require written practice also provide feedback to the teacher that permit the teacher to better direct the instruction of each student in subsequent lessons. Activity sheets can differ from tests in that the performance of each student in completing the activity sheets does not affect the student's grade in the class. In an alternate embodiment, the activity sheets may be evaluated and can affect the students' grades in the class. Activity sheets also allow the teacher to hold each student accountable for paying attention to and learning the subject matter of the recorded lesson. The activity sheets may also include questions requiring written response, illustrations, word problems, fill-in-the-blank statements, matching problems, true-or-false questions and statements, multiple choice questions, or a combination of these.

In an exemplary embodiment, the recorded lesson may focus on comparison and contrast so that the activity sheets can contain an exercise in which the students compare and contrast two or more persons or objects using Venn diagrams. The Venn diagrams can include two or more overlapping circles where indicia printed in the outer (non-overlapping) parts of the circles describe how the persons or objects being compared differ while indicia printed in the inner (overlapping) parts of the circles describe how the persons or objects being compared demonstrate likeness or similarities.

In a different exemplary embodiment, the recorded lesson may focus on the skill of determining or recognizing cause and effect so that the activity sheets can contain space for drawing illustrations that are then labeled by the student to demonstrate cause and effect. For example, to demonstrate the student's understanding of cause and effect, the student may be required to draw a first picture of a student studying for a test and second picture of the student bringing home the test with an “A” grade or evaluation. The student may write a sentence describing what is shown in each picture, provide a first mark identifying a “cause” portion of the sentence, and provide a second mark identifying an “effect” portion of the sentence.

The system may also include a teacher's manual having sections containing a plurality of teaching materials as well as explanations of multiple styles and methods for teaching a skill in connection with the academic subject of the recorded lesson. The teacher's manual may provide examples of styles and methods to teach the live lecture or live lesson visually, aurally, and kinesthetically. Students may learn differently and the teacher's manual can provide examples of different styles and methods of teaching the subject matter of the recorded lesson. The teacher's manual may also contain teacher-copies of each activity sheet and test or quiz used during the recorded lessons as well as activity sheets for use in remedial lessons for students who have not mastered the subject matter after the first completion of the recorded lesson.

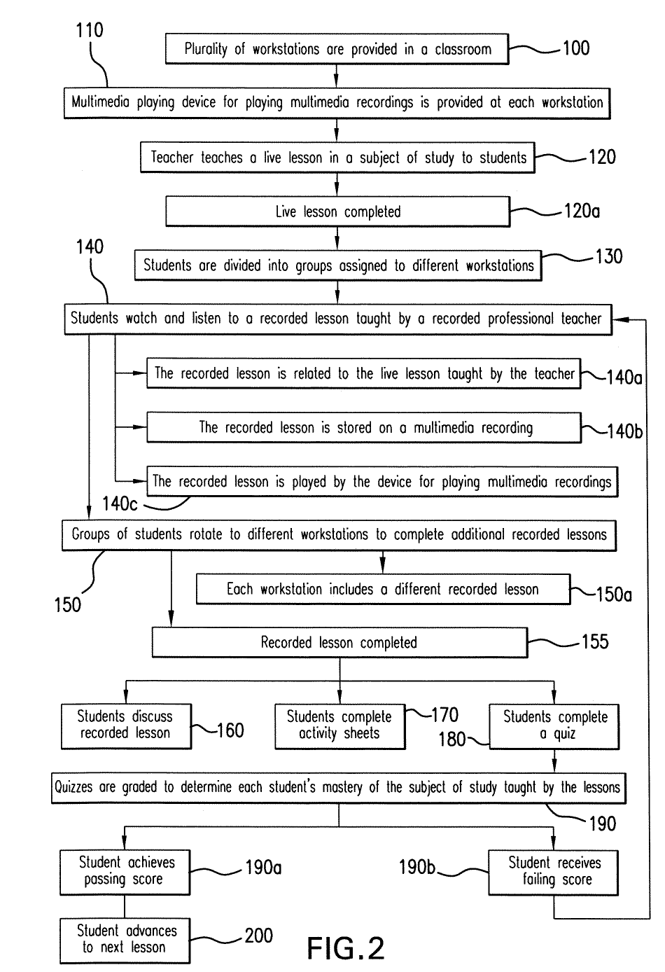

Referring now to FIG. 2, an improved teaching method allows students to see and listen to a teacher provide a targeted lesson or teach a skill in a given subject of study and to practice and enhance the lesson or skill immediately following instruction. In an exemplary embodiment, the method is used for teaching students (e.g., kindergarten, 1^{st}, 2^{nd}, 3^{rd}, 4^{th}, 5^{th}, or 6^{th} grade students) phonics and reading skills, such as digraphs, blends, short vowels, long vowels, author's purpose, main idea, cause and effect, comparison and contrast, characters in a story, and setting of a story, among others. The method may also be used to teach and reinforce lessons and skills in other subjects of study including but not limited to literature, spelling, mathematics, social studies, history, health, science, political science, economics, foreign language, business, accounting, religion, and fine arts. Using the method, a teacher can provide individual or small group instruction to students where needed without interrupting instruction of the entire class of students to accommodate the additional needs of only one pupil or a few students.

In the present method, first 100, several workstations are provided in at least one classroom. The number of chairs or amount of seating space can be varied at each workstation according to the number of students assigned to each subgroup workstation by the teacher.

In another step of the method 110, at least one device for playing audio and video recordings, or recording playback device, can be provided at each workstation.

In another step of the method 120, a live lesson or live lecture is presented to a group of students in a selected academic subject of study. More than one teacher or educator may be used to teach the live lesson of this method. Instruction by the teacher can provide the students with a brief overview of the material that is to be elaborated on or reinforced in the workstations. The live lesson is essential for providing the students with information about the subject matter to be learned in the recorded lesson. The live lesson also provides the educator with an opportunity to assess the skill level, knowledge, and academic abilities of the students through, for example, a question and answer session related to the subject matter presented by the educator during or after the live lecture.

In another step of the method 130, immediately (e.g., within 1, 5, or 10 minutes) after the teacher finishes teaching the live lesson 120a, when the lesson is still fresh in the students' minds, the teacher divides the students into subgroups (e.g., 2, 3, 4, 5, or 6 subgroups) which are each assigned to a different workstation. Students may be assigned different responsibilities at each workstation including but not limited to the responsibilities of activating the first recorded lesson, stopping the first recorded lesson, rewinding the first recorded lesson, returning the first recorded lesson to an educator, distributing at least one activity sheet to the students in the first subgroup, collecting the activity sheets from the students in the first subgroup upon completion of the activity sheets by the students, evaluating the activity sheets completed by the students in the first subgroup, distributing at least one quiz to the students in the first subgroup, collecting the quizzes from the students in the first subgroup upon completion of the quizzes by the students, evaluating the quizzes completed by the students in the first subgroup, returning the completed activity sheets to the educator, returning the completed quizzes to the educator, distributing at least one book, sample of literature, printed chart or diagram, educational game, or manipulative related to the academic subject of the first recorded lesson to the students in the first subgroup, collecting the books, samples of literature, printed charts or diagrams, educational games, or manipulatives from the students in the first subgroup upon completion of the first recorded lesson, returning the books, samples of literature, printed charts or diagrams, educational games, or manipulatives to the educator, and leading a discussion about the first recorded lesson with students in the first subgroup. One or more students at each workstation may also be assigned the responsibility of delivering completed recorded lessons to another subgroup of students. The students may be divided by the teacher into subgroups 130 based upon skill level or ability, with students of similar ability being grouped together, or the students may be divided randomly with each subgroup containing students having a variety of skill levels. In one embodiment, the students may be divided into subgroups based upon the method or style of teaching that most effectively assists the students in learning the academic subject being taught.

In another step of the method 140, one or more of the subgroups of students can be required to watch or listen to a recorded lesson 140 played by the audio and video playing device 140c. One of the subgroups of students might also be sent to a workstation with a live teacher who could present an additional live lesson or otherwise address the individual needs of students in that subgroup. For example, the teacher might review activity sheets with students, and in particular, with students exhibiting a need for remedial lessons in the academic subject being taught. In another example, the teacher might replay the recorded lesson and provide additional instruction to the students as the recorded lesson is replayed. In still another example, the teacher may provide additional instruction to the students following the recorded lesson.

In one embodiment of the invention, the recorded lessons can provide immediate feedback to the students by including recorded instructions to the students for awarding points based upon correct responses by the students to activity sheet, quiz, and test questions.

In an exemplary embodiment, the recorded lessons can be created and recorded by professional teachers and educators. In an alternate embodiment, the recorded lessons may be created and recorded by the classroom teacher, for example, by providing blank recording media onto which the teacher may record lessons prepared using a teacher's manual.

The recorded lessons may use audio and video instructions from the recorded professional teacher to present the subject matter of each lesson or the recorded teacher may contribute his or her voice to puppets or animated video characters that may be utilized. In one embodiment, the recorded lesson may be identical or substantially similar to the live lesson taught by the teacher 140a for purposes of providing remedial instruction to one or more students. The recorded lesson may be presented in a style that includes a visual format, verbal format, auditory format, kinesthetic format, or any other suitable method or style of teaching that most effectively assists the students in learning the recorded lesson. Multiple teaching methods (e.g., visual, auditory, etc.) may be utilized at different workstations to teach the students. The students may be assigned to the workstation or workstations which include recorded lessons using the teaching style or method under which each student learns most effectively. In an exemplary embodiment, each subgroup of students may be exposed to different styles of teaching by rotating recorded lessons including at least a first style of teaching and recorded lessons including at least a second style of teaching between the subgroups. In this exemplary embodiment, the first style of teaching can differ from the second style of teaching.

In an exemplary embodiment, the recorded lesson may be presented to the students in a multimedia format 140b although, in other embodiments, purely audio or purely video recordings may also be used. Multimedia recordings may be more useful for holding the attention of some students than recordings that are only audio or only video. A different recorded lesson can be provided at each workstation in the classroom. For example, a first recorded lesson reviewed and learned by a first subgroup of students may relate to phonics while a second recorded lesson reviewed and learned by a second subgroup of students might relate to grammar. The recorded lessons may incorporate real-world literature, facts, events, or art.

The teacher may provide individual or small group instruction to individuals or groups exhibiting greater need or lack of understanding during the recorded lessons portion of the method. By providing individual and small group instruction during the recorded lessons, the teacher can reduce or eliminate interruptions to the teaching of the entire class based upon the need for additional instruction of only one student or a small number of students.

In an alternate embodiment, the teacher may assign lessons that are not recorded lessons to at least one of the subgroups of students. These unrecorded lessons can include, for example, individual reading assignments, group reading assignments, individual completion of activity sheets, or group completion of activity sheets. For example, one subgroup of students may be viewing and listening to a recorded lesson and another subgroup of students may be engaged in individual reading lessons. These unrecorded lessons can be assigned to the second subgroup of students within ten minutes of the conclusion of the live lecture and may optionally be in the same academic subject as the live lecture.

In another alternate embodiment of the invention, the teacher may assign lessons to one or more subgroups of students that pertain to a different academic subject than the academic subject of the live lecture. For example, if the live lecture pertains to spelling and grammar, the assigned lesson may relate to reading comprehension. These lessons can be assigned to the second subgroup of students within ten minutes of the conclusion of the live lecture.

In another step of the method 150, upon completion of each recorded lesson, the subgroups of students are optionally rotated to different workstations to complete additional recorded lessons or to meet with a live teacher. In one embodiment, each recorded lesson is five to eight minutes in length so that the student subgroups are rotated between workstations to watch and listen to several different recorded lessons during a normal 45 to 90 minute class period 150a. Although not required, the rotations of the subgroups of students can be repeated among the workstations until all students have completed each of the different recorded lessons. In one embodiment, the subgroups of students are rotated until all of the subgroups have completed at least one of the recorded lessons during a 45 to 90 minute class period.

In an alternate embodiment of the invention, the recorded lessons may be rotated among the workstations rather than requiring rotation of the subgroups of students between workstations. This alternate embodiment is particularly desirable when maintaining discipline and good behavior among the students is an objective.

In another embodiment, the student subgroups are rotated between workstations on different days to complete each of the recorded lessons. One or more recorded lessons may be completed by each subgroup each day.

In another embodiment, the recorded lessons are rotated among the workstations on different days to allow each student subgroup to complete different recorded lessons. In this embodiment, again, one or more recorded lessons may be completed by each subgroup each day.

An additional step of the method 170 may include providing the students with one or more activity sheets to be completed either before, during, or after completion of a recorded lesson 155 watched or listened to by the students. The teacher may require completion of activity sheets by the students in connection with each recorded lesson or only in connection with particular, predetermined lessons or those lessons selected by the teacher. The activity sheets may be collected by the teacher for performance evaluation, may be graded by each student, or may be completed by the students without grading. The activity sheets may be used by the teacher as an informal assessment tool to determine whether remedial materials are appropriate for a student either in-class or as homework.

In addition to the completion of activity sheets, students may be required to complete an evaluation activity 180, such as a test or quiz, after completion of one or more of the recorded lessons 155. The evaluation activity can be timed so as to require completion of the test or quiz by each student within a predetermined period of time (e.g., 3, 5, 7, or 10 minutes). When this step is included, the teacher may collect the tests or quizzes from the students to review and grade each student's test or quiz 190 to determine each student's comprehension and mastery of the subject of study taught by the lessons. In an alternate embodiment of the invention, the test or quiz is conducted and graded by a computer to evaluate each student's comprehension and mastery of the subject of study taught by the lessons. Students who achieve a passing score 190a on the test or quiz advance to the next lesson 200 in the curriculum. Students who fail to meet a predetermined level of performance 190b on the test or quiz may be required to repeat 140 one or more of the recorded lessons. The evaluation activity can be designed so that the student's level of performance on the test or quiz is indicative of the student's comprehension and mastery of the subject of study taught by the live and recorded lessons. The test or quiz, or the activity sheets, may be evaluated to determine the most effective manner for teaching each student, e.g., visually, verbally, or kinesthetically, so that the method may be adjusted for optimum teaching and learning for each student.

Upon completion of the recorded lesson and following the teacher's assessment of any activity sheets and quizzes completed by the students, the teacher may select a few (e.g., 1, 2, 4, 6, or more) students to whom the teacher provides remedial lessons related to the subject matter of the live lecture and recorded lesson. In another embodiment, the students may be permitted to continue reviewing and completing additional recorded lessons at the workstations. In still another embodiment, the teacher may resume the live lecture for the entire group of students after the teacher completes the assessment of the students' performance and mastery of the subject matter of the recorded lesson as demonstrated by each student's completed activity sheet test, or quiz or as determined by the teacher through teacher observation of and teacher dialogue with the students. In another embodiment, one or more recorded lessons may be replayed and additional instruction simultaneously provided by the teacher or educator to the students of one or more of the subgroups while the recorded lesson is replayed.

Another additional step of the method may require that, upon the completion of each recorded lesson 155, the students discuss the subject matter 160 of the recorded lesson amongst themselves or with the teacher. The books, which can be textbooks, workbooks, or samples of literature, may be used in conjunction with the recorded lessons by requiring that the students follow and review sections of the books related to the recorded lesson as the recorded lesson is being played.

In another additional step of the method, students who demonstrate understanding of the academic subject taught by one or more of the recorded lessons may be provided incentives. In one embodiment, incentives may be provided to the students to complete one or more of the recorded lessons. These incentives may be discussed with the students prior to beginning the recorded lessons to encourage the students to focus during the recorded lesson and to complete the recorded lesson. The incentives may be given to the students in the form of rewards after completion of one or more of the recorded lessons. Rewards that may be used as incentives include, for example, appointment as line leader for the group of students, candy and other food items, stickers and other prizes, toys, exemptions from homework assignments, books, additional recess time, additional computer time, being permitted to watch a movie, school district recognition of the student, school-wide or classroom recognition, and positive marks on a performance chart maintained for each student. In one embodiment, the incentives may be provided to students based upon each student's performance on the activity sheets or quizzes.

In still another step of the method, incentives may be provided to subgroups of students who complete one or more of the recorded lessons rather than to students on an individual basis.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for teaching a group of students in a classroom, the method comprising the steps of:
(a) presenting a live lecture in an academic subject to the group of students;
(b) dividing the group of students into a plurality of subgroups, the plurality of subgroups comprising at least a first subgroup of students and a second subgroup of students;
(c) placing the first subgroup of students into a first workstation and placing the second subgroup of students into a second workstation, the first workstation being separated from the second workstation; and
(d) within ten minutes of the conclusion of the live lecture, activating a first recorded lesson in the first workstation having therein the first subgroup of students, the first recorded lesson relating to the academic subject and comprising an audiovisual recording of a person presenting the first recorded lesson.

2. The method of claim 1, further comprising at least one step selected from the group consisting of:
(e) within ten minutes of the conclusion of the live lecture, activating a second recorded lesson in the second workstation having therein the second subgroup of students, the second recorded lesson relating to the academic subject, comprising an audiovisual recording of a person presenting the second recorded lesson, and differing from the first recorded lesson;
(f) within ten minutes of the conclusion of the live lecture, presenting a live lesson to the second subgroup of students in the second workstation;
(g) within ten minutes of the conclusion of the live lecture, assigning lessons to the second subgroup of students that are not recorded lessons; and
(h) within ten minutes of the conclusion of the live lecture, assigning lessons to the second subgroup of students that are unrelated to the academic subject of the live lecture.

3. The method of claim 1, further comprising the step of:
(i) assigning one of the students of the first subgroup of students with one or more tasks selected from the group consisting of: activating the first recorded lesson, stopping the first recorded lesson, rewinding the first recorded lesson, returning the first recorded lesson to an educator, distributing at least one activity sheet to the students in the first subgroup, collecting the at least one activity sheet from the students in the first subgroup upon completion of the at least one activity sheet by the students, evaluating the at least one activity sheet completed by the students in the first subgroup, distributing at least one quiz to the students in the first subgroup, collecting the at least one quiz from the students in the first subgroup upon completion of the at least one quiz by the students, evaluating the at least one quiz completed by the students in the first subgroup, returning the completed at least one activity sheet to the educator, returning the completed at least one quiz to the educator, distributing at least one book, sample of literature, printed chart or diagram, educational game, or manipulative related to the academic subject of the first recorded lesson to the students in the first subgroup, collecting the at least one book, sample of literature, printed chart or diagram, educational game, or manipulative from the students in the first subgroup upon completion of the first recorded lesson, returning the at least one book, sample of literature, printed chart or diagram, educational game, or manipulative to the educator, and leading a discussion about the first recorded lesson with students in the first subgroup.

4. The method of claim 1, further comprising the step of:
(j) providing an activity sheet to each student in the first subgroup of students.

5. The method of claim 1, further comprising the step of:
(k) administering a quiz to each student in the first subgroup of students, the quiz comprising at least one question in the academic subject.

6. The method of claim 1, further comprising the step of:
(l) assigning one of the students of the first subgroup of students to deliver the first recorded lesson upon completion by the first subgroup of students to the second subgroup of students.

7. The method of claim 1, further comprising at least one step selected from the group consisting of:
(m) reviewing at least one activity sheet completed by one or more students in one or more of the subgroups to determine each student's comprehension and mastery of the academic subject taught by the recorded lesson;
(n) reviewing and grading at least one activity sheet completed by one or more students in one or more of the subgroups to determine each student's comprehension and mastery of the academic subject taught by the recorded lesson; and
(o) reviewing and grading at least one test or quiz completed by one or more students in one or more of the subgroups to determine each student's comprehension and mastery of the academic subject taught by the recorded lesson.

8. The method of claim 7, wherein students who fail to meet a predetermined level of performance on the test or quiz are required to repeat one or more of the recorded lessons; and
wherein the student's level of performance is indicative of the student's comprehension and mastery of the academic subject taught by the recorded lessons.

9. The method of claim 1, further comprising the step of:
(p) upon the completion of each recorded lesson, requiring that the students in the subgroup completing the recorded lesson discuss the recorded lesson.

10. The method of claim 1, further comprising the step of:
(q) rotating the subgroups of students to different workstations upon completion of one or more recorded lessons to complete additional and different recorded lessons.

11. The method of claim 1, wherein the first recorded lesson differs from a second recorded lesson in level of difficulty.

12. The method of claim 1, further comprising at least one step selected from the group consisting of:
(r) upon completion of the first recorded lesson by the first subgroup, rotating the first recorded lesson to the second subgroup for review and completion of the first recorded lesson by the students of the second subgroup;
(s) upon completion of the second recorded lesson by the second subgroup, rotating the second recorded lesson to the first subgroup for review and completion of the second recorded lesson by the students of the first subgroup;
(t) providing incentives to students who demonstrate understanding of the academic subject taught by one or more of the recorded lessons; and
(u) providing incentives to subgroups of students who demonstrate understanding of the academic subject taught by one or more of the recorded lessons.

13. The method of claim 1, further comprising the step of:
(v) assessing each student to determine a style of teaching in which the student learns most effectively, the style of teaching being selected from the group consisting of: visual lessons, auditory lessons, verbal lessons, kinesthetic lessons, any other suitable manner of teaching students, and combinations thereof.

14. The method of claim 13, further comprising at least one step selected from the group consisting of:
(w) dividing the students into subgroups based upon the style in which each student has been assessed to learn most effectively; and
(x) using different styles of teaching for each subgroup of students by rotating at least the first recorded lesson comprising a first style of teaching and at least the second recorded lesson comprising a second style of teaching between the subgroups, wherein the first style of teaching differs from the second style of teaching.

15. The method of claim 1, further comprising the step of:
(y) resuming the live lecture for the entire group of students after an educator assesses the mastery of the academic subject of the recorded lesson by the students as demonstrated by each student's performance on one or more completed evaluation activities selected from the group consisting of: activity sheets, quizzes, tests, teacher observation, teacher dialogue with students, and combinations thereof.

16. The method of claim 1, further comprising the step of:
(z) providing remedial live lessons by an educator to students in at least one of the subgroups in the academic subject taught by one or more of the recorded lessons.

17. The method of claim 1, further comprising at least one step selected from the group consisting of:
(aa) replaying one or more of the recorded lessons to at least one subgroup and providing additional instruction by an educator to the students of the at least one subgroup as the recorded lesson is replayed;
(bb) replaying one or more of the recorded lessons to at least one subgroup and providing additional instruction by an educator to the students of the at least one subgroup after the recorded lesson is replayed; and
(cc) providing immediate feedback to the students by having instructions in the recorded lessons for awarding points based upon correct responses by the students to activity sheet, quiz, and test questions.

18. A kit comprising:
a plurality of recordings of a person presenting a lesson, the plurality of recordings comprising at least a first recording of a first lesson and a second recording of a second lesson wherein the second lesson differs from the first lesson; and
a teaching implement selected from one or more of the group consisting of:
a textbook to be reviewed and followed by students during a live lecture, during a recorded lesson, or during both the live lecture and the recorded lesson;
samples of literature for review by the students;
printed charts and diagrams for review by the students;
educational games;
manipulatives,
activity sheets;
quizzes;
tests; and
a teacher's manual, comprising a version of the textbook containing explanations and examples of teaching styles and methods, answers to activity sheets, and answers to quizzes.

19. The kit of claim 18, wherein the first lesson is taught using a first style of teaching and the second lesson is taught using a second style of teaching, the second style of teaching being different from the first style of teaching.

20. The kit of claim 18, wherein the activity sheets comprise questions and exercises for assessing each student's mastery of the lesson and ability to continue with subsequent lessons and the most effective style for teaching each student; and wherein the quizzes comprise questions and other evaluative exercises for evaluating each student's mastery of the lesson and for providing a grade for each student in an academic subject that is being taught.
